(19) United States
(12) Patent Application Publication
(10) Pub. No.: US 2007/0174170 A1
(43) Pub. Date: Jul. 26, 2007

(54) Combined 1031-1033 Exchange

(76) Inventor: R. O'Neal Gray, Dallas, TX (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(21) Appl. No.: 11/674,950

(22) Filed: Feb. 14, 2007

(51) Int. Cl. G06Q 40/00

(52) U.S. Cl. 705/36 T

(57) ABSTRACT

The invention is a method of deferring taxes on real estate property by exchanging investment real estate property under IRS 1031 exchange rules for a real estate property that is subject to condemnation. The property subject to condemnation is then sold, and the owner claims the benefit if a 1033 exchange, and may replace the property within the allowed 1033 replacement period.

### FIELD OF THE INVENTION

The present invention relates generally to methods and investment instruments for performing tax-deferred real estate transactions, and more particularly to methods and instruments for performing tax-deferred exchanges of real estate under 26 U.S.C. §1031 and 1033.

### BACKGROUND OF THE INVENTION

The tax code provides a period of time for owners of investment property a period of time in which to complete an exchange of like kind property without incurring tax consequences. Currently, the period of time is 180 days, see 26 U.S.C. §1031, incorporated by reference. However, if the property is subject to conversion (destruction, condemnation or threat of imminence condemnation) the tax code provides an extended period of time within which to exchange property that is subject to condemnation, up to about two or three years from the sale or disposition of the real property. See 26 U.S.C. §1033, incorporated by reference.

A 1031 Exchange

Title 26, Section 1031 of the Internal Revenue Code permits deferral of the taxes on investment real estate by reinvesting in other investment real estate, subject to several conditions imposed by the Section 1031. A §1031 Exchange is a transaction in which a taxpayer is allowed to sell one property and buy another without a tax consequence. A successful exchange results in the taxpayer being able to utilize 100% of the proceeds from the sale of property to purchase a new property, thereby deferring the capital gains taxes and sometimes even more importantly, avoid the recapture of depreciation. To avoid the payment of capital gain taxes the exchanger should follow three general rules:

1. Purchase replacement property that is the same or greater value as the relinquished property.

2. Reinvest all of the exchange equity into the replacement property.

3. Obtain the same or greater debt on the replacement property as on the relinquished property. The Exchanger can offset the amount of debt obtained on the replacement property by putting the equivalent amount of additional cash into the exchange.

A §1031 exchange is usually a three-way delayed exchange, referred to as a “Starker Exchange”, in which an intermediary is used to facilitate the transaction. There are four basic steps:

1. Seller arranges for sale of the “relinquished property” and includes exchange language in the contract.

2. At closing, sales proceeds go to a Qualified Intermediary for a §1031 exchange.

3. Seller identifies potential exchange “replacement properties” within 45 days of closing on the relinquished property.

4. Seller completes the §1031 exchange within 180 days of closing.

In a §1031 transaction, these steps can also occur simultaneously.

Section 1031 of the Internal Revenue Code lays out in detail the procedure and requirements for a tax-deferred exchange. It specifies that the properties must be held for investment or business purposes and that these properties being exchanged must be “like-kind,” referring to the type of property being exchanged (real estate, personal property, etc.) and not its grade or quality. Qualifying property is broadly defined, for both the property being transferred and that received, as realty used for investment or business purposes.

In effect, all investment real estate, whether it is an office building or a vacant lot, can be exchanged to any other piece of investment property. Consequently, investment realty (held for either appreciation or rental) can be exchanged for real property used in a trade or business and vice versa.

Section 1031 describes the need of a “safe harbor,” such as a Qualified Intermediary (QI), to facilitate the exchange. The exchanger must not have “Constructive Receipt” of the sale proceeds—no cash or other benefits can go to the exchanger, an important limitation on a 1031 exchange.

If an exchanger actually or constructively receives non-like-kind property known as boot (e.g., money or personal property) for the relinquished realty anytime before receiving the like-kind replacement property, the transaction is a sale and not a deferred 1031 exchange.

The QI is an entity or individual independent of the exchanger and not deemed to be its agent, either objectively or subjectively. The QI is the recipient of the net proceeds from the closing of the relinquished property, with the money impounded for subsequent reinvestment into other realty. Any earnings on these monies may not be paid to the exchanger until the end of the exchange.

In a three-party deferred exchange, the QI is the third party, with the other two being the exchanger and the replacement property owner. IRS Revenue Ruling 2002-83 prohibits a QI from using the impounded funds to acquire the property of a party related to the exchanger to be used as the replacement realty. Such a disposition by the related party would be deemed a sale under IRC 1031(f), precluding any party from cashing out during the two-year period following the exchange.

The code also sets a strict timeline for the completion of an exchange. The most commonly used method of performing a 1031 exchange, is when the exchanger closes on the relinquished property before closing on the replacement property. Before the relinquished property is sold, the intention of completing a 1031 exchange with the property must be declared, and an exchange agreement must be made between the exchanger and a qualified intermediary (QI).
Delayed exchanges must be completed within strict time limits with absolutely no extensions. The Exchanger has 45 days from the date the relinquished property closes to “Identify” potential replacement properties. This involves a written notification to the Qualified Intermediary listing the addresses or legal descriptions of the potential replacement properties.
Once the Identification period is completed, the exchanger has the remainder of the 180 days (beginning with the closing of the relinquished property) to close on at least one of the identified properties. If the exchanger fails to close within this time period, then the exchange is busted and the exchanger must pay the capital gains tax.

There are three ways to identify properties the exchanger wishes to purchase. By far, the most common is the “3-property” rule. In this rule, the identification period begins with the sale of the relinquished property and gives the exchanger 45 days to identify up to 3 possible investment properties. If the exchanger has no possible exchange properties at the end of this 45 day time period, or the properties that were identified are no longer available, then the exchange is busted and the exchanger must pay the capital gains tax.

The regulations permit more than one property to be identified as replacement property. The maximum number of replacement properties which the exchanger may identify under the regulations is as follows:
(i) Three properties of any fair market value (FMV); or
(ii) Any number of properties, as long as the aggregate FMV of all properties identified as of the end of the identification period does not exceed 200% of the aggregate FMV of all relinquished properties as of the date of transfer; or
(iii) Under the 95% rule, an exchanger is permitted to identify any number of properties of any total value, provided that 95% of what has been identified is actually acquired within the 180-day replacement period.

Replacement property acquired during the 45-day period reduces the number of properties that can be identified under the above rules.

For instance, the new property (the “replacement property”) must have both value and debt that are equal to or greater than the value and debt of property being sold (the “relinquished property”). If the value or debt of the replacement property is less than that of the relinquished property, taxes are payable on the difference, known as “boot”.

The following sequence represents the order of steps in a typical 1031 exchange.

1. An investor decides to sell investment property and do a 1031 exchange. He contacts a qualified intermediary (QI) and they enter into an agreement.

2. The investment property is put on the market.

3. An offer to purchase the investment property is accepted and signed by the QI.

4. Escrow for the sale is opened, and a preliminary title report is produced.

5. The QI sends required exchange documents to the escrow closer for signing at property closing.

6. Escrow closes.

7. Within the first 45 days after the close of escrow on the sale of the relinquished property, the investor identifies replacement properties as required by law. This is known as the “Identification Period”.

8. Within 180 days after the close of escrow on the sale of the relinquished property, the investor closes on one of the replacement properties which he has identified. This is called the “Exchange Period”. This completes the exchange. No cash—or “boot”, as it is known—is taken by the exchanger.

TIC 1031 Exchanges

IRC section 1031 exchanges help in meeting the concerns of many investors by permitting a tax-deferred exchange. However, the 180 day time limit presents problems for a 1031 exchange. One system to manage a 1031 type exchange and deal with the time limitations is disclosed in U.S. Pat. No. 6,292,788 (hereby incorporated by reference). The system presented creates a new type of investment instrument, a “deedshare” that represents a tenant-in-common (TIC) interest in real estate, providing divisibility and liquidity of a traditional security. As a “share” in real estate, the owner of a deedshare would be provided a share of the income stream (if any) generated by the underlying property. This patent claims that such deedshares are suitable for identification as replacement property under IRC section 1031, may be encumbered by a mortgage as required by the particular needs of an individual investor, so as to comply with the debt provisions of IRC section 1031. This patent describes an entity that manages the exchanges, the properties, and describes structures for management of the property and disposal of the property subject to the deedshares. The management structure is utilized to prevent the TIC owners from exercising significant control over the real estate, and hence, the co-owners should not be considered partners, as partnerships do not qualify for 1031 exchanges.

The ability to aggregate property and own in in-division as Tenants in Common (TIC) with other owners is subject to IRS rules, and in particular, IRS Revenue Procedure 2002-22 (hereby incorporated by reference). These Rules must be accounted for in the management structure and Co-Owner's Agreement (described below) as best as possible so that the TIC exchange qualifies for a 1031 exchange.

In a TIC exchange, the exchanger's replacement property is a co-ownership interest in properties (one or more aggregated properties) with others in indivision. The ownership interest should be in property of like kind and “equal value” in accordance with the section 1031 rules. In a 1031 TIC Exchange, the “exchanged property” is a form of real estate asset ownership in which two or more persons have an undivided, fractional interest in the asset. Ownership shares are not required to be equal. Each co-owner receives an individual deed at closing for his or her undivided percentage interest in the entire property. In brief, a TIC owner has the same rights and benefits as a single owner of property.

Although the TIC ownership form has been used in 1031 exchanges for some time, its popularity is increasing as Exchangers often have difficulty in locating and closing suitable replacement property within the 45 day identification period and the 180 day closing period. 1031 TIC exchanges can significantly reduce these risks.

A 1031 TIC structure allows investors to pool their resources and purchase larger, higher valued and better positioned properties than they might otherwise have access. TIC 1031 tenant in common exchanges are typically handled through broker-dealers or sponsors (such as attorneys, real estate brokers, etc) and may be under the oversight of the Securities and Exchange Commission (SEC).

Co-ownership Agreement

TIC structured exchanges are generally formed with an in-place TIC Agreement or co-ownership agreement. This agreement describes the relationship between the investor and all of the other TIC owners. The rights and obligations of the Tenants-in-Common are governed by this agreement. The co-owners will usually enter into a Co-owners Agreement governing the relationship of the co-owners using IRS rulings as guidelines. For instance, the Co-owner's Agreement may include a provision by which the tenant-in-common deeds may be “reaggregated” after a specified interval, so that the property may be disposed of. Alternatively, the Agreement may specify that no co-owner has the right to seek partition of the co-owned property. The Co-owner's Agreement may run with the land (for instance, the agreement may include giving the other co-owners first right of refusal to purchase their interest at fair market value). It is preferred that the Co-owner's Agreement require unanimous approval by the co-owners for the negotiation/renegotiation of a contract for, and hiring of a property manager, for the sale of the property and any lease for a portion or all of the property. For other actions, the co-owners can agree to be bound by the outcome of a vote decided by those holding 50% or more of the undivided interest; however, a proxy to the Manager might be sufficient. In general, each owner must have the right to transfer its interest in the property without approval of any person (exceptions to this rule are any restrictions required by a lender as long as they are consistent with “customary commercial lending practices”). When the property is sold, all debt must be paid off prior to distribution of any profits to owners. Each owner must share in all of the income and expense associated with the property according to the proportionate share of its undivided interest; each owner must share in debt that is secured by a mortgage on the property as a whole, in proportion to its undivided interest. Any co-owner may issue an option to purchase its interest provided that the price reflects its fair market value of the property at the time the option is exercised. If the agreement calls to unanimous consent to lease, it is preferred that the property also be burdened with a master lease agreement with a master lessee, (later described) with the master lessee having the right to sublease.

The Co-owner's Agreement preferably comprises provisions that prevent co-owners from providing common services with respect to the commonly owned real estate, from entering into joint venture activities with respect to real estate with fellow owners, from commingling or establishing joint financial arrangements with respect to real estate with other co-owners and other activities that may subject the co-owners to partnership rules. The Co-owner's Agreement will generally include provisions for a Management Agreement providing for management of the properties by an independent third party.

The Management Agreement

In addition to the TIC Agreement, offerings are generally structured with an additional document signed by each TIC owner providing a manager with the ability to handle the day-to-day activities of the property (a Management Agreement). Thus the TICs have little required of them in the way of management. Generally, the co-owners will enter a Management Agreement allowing a manager to manage the property subject to limitations. In general, a sponsor will set up the properties and management structure for purposes of selling the arrangement as a packaged TIC 1031 exchange. Management and/or Brokerage Agreements, Sponsors fees charged for all brokerage and management agreements, all should be at fair market value and be renewed no less than once a year. The fees negotiated for these services should not be dependant on the amount of income received from the property. Any payment to a Sponsor for the acquisition of the TIC interest must reflect the fair market value for the service and the value of the interest at the time of the purchase. Other IRS guidelines may apply, for instance, all lease agreements should reflect their fair market value for the specific type of use specified in the lease. The manager may be given the right to lease and sublease, maintain the properties, pay taxes, etc. The Management Agreement generally is structured to run with the Co-owner's Agreement and be an obligation binding upon the purchaser of a co-owners' interest.

The TICs pay the Management Company an annual management fee. Normally, the structure is a full pass thru arrangement with the TIC owners receiving 100% of the property net operating income, after debt services.

As can be seen, limitations of the 1031 exchange are the inability of the exchanger to access funds form the sale of his/her exchange property, and the time limitations needed to find replacement property. The TIC structured 1031 exchange has helped alleviate the impact of the time restrictions imposed on 1031; however, the inability to access funds from the sale of the exchanged property still presents a limitation.

Section 1033 exchanges

Section 1033 exchanges of “converted property” are subject to different rules from that of a 1031 exchange. If a taxpayer's property is involuntarily converted, Section 1033 of the Internal Revenue Code can provide relief. An involuntary conversion occurs when property is destroyed, stolen, condemned, or disposed of under the threat of condemnation, and other property or money is received in payment.

In particular, states, counties, cities, and other government entities often find it necessary to acquire realty, sometimes against the wishes of the property owner. Given recent court rulings, this practice is expected to increase. If an investor's property is involuntarily converted by a governmental or quasi-governmental agency through a condemnation or a negotiated sale under the threat of condemnation (the sale does not have to be to the condemning authority) and the investor has a gain resulting from the involuntary conversion, he or she may elect to postpone recognition of that gain by buying a qualified replacement property within a specified replacement period. The basis of the investor's replacement property is reduced by the non-recognized gain, similarly to a 1031 exchange.

The tax deferral provisions of §1033 are, in many ways, more generous to the investor than the §1031 rules. For instance, the §1033 roll-over exchange does not require application of the technical rules of a §1031 exchange. As a result, there are no concerns about the investor's constructive receipt of funds and no requirement that a qualified intermediary be involved in the transaction.

The involuntary conversion rules permit investors who sell under the threat of (or imminence of) requisition or condemnation to defer the gain on the sale. The IRS's position is that the threat of (or imminence of) requisition or condemnation exists when the taxpayer learns through a reliable source that a governmental or quasi-governmental entity has decided to acquire the taxpayer's property, but only if there are reasonable grounds to believe that the condemnation or requisition will actually occur. See Rev. Rul. 63-221. The threat or imminence of condemnation thus exists if a taxpayer is faced with the alternative of either selling the property to the government, a quasi-governmental entity, or a third party; or having the property condemned. A threat of condemnation need not be a certainty. It exists if it might reasonably be believed from representations of government agents and surrounding circumstances that a condemnation is likely to take place.

Investors are granted a period in which to replace the involuntarily converted property (“IC Property”)(“IC Property” refers to property subject to the threat of imminent conversion or condemnation, and also includes property subject to a notice of conversion or condemnation, where the actual transfer of title has not taken place). The time period within which replacement can take place begins on the date of disposition of the IC Property (the date of destruction, seizure, condemnation or the date of the sale of the property under threat of condemnation) or the earliest date of the threat or imminence of condemnation, and ends three years after the close of the first taxable year in which any part of the gain upon condemnation is realized. (IRC §1033(g) (4)) (e.g. ends on the third anniversary of the end of the year in which the involuntary conversion took place). Any other type of property disposed of in a condemnation sale is required to be replaced within two-years from the end of the year in which the involuntary conversion takes place, unless subject to special extensions for property within Presidentially declared disaster areas. With hurricane damages increasing, condemned property in Presidentially declared areas is expected to increase.

Note that the sale of property under threat or imminence of condemnation is considered an involuntary conversion. Further, a purchaser of property subject to condemnation prior to the purchase may also qualify for the 1033 exchange benefits if selling to another third party. Also, such a purchaser, if selling to the condemning authority, qualifies for a section 1033 exchange on the proceeds of the sale. See Dept. Treasury, IRS Publication 544.

For real estate used for investment or business purposes, qualified replacement property is “like-kind property” as defined under the rules of IRC §1031 tax-deferred exchanges (Regs. §1.1033(g)-1(a)). This means that any type of real property held for investment purposes will qualify for replacement of the sale of the converted property. The replacement property may be improved or unimproved under these rules. It is even possible to construct improvements on land that the investor already holds title on.

There are no requirements for escrowing cash received from a condemnation sale under §1033. Investors can use the cash as they wish. The replacement property may be 100% financed without using any of the cash you received from the sale of the condemnation property. There are no requirements for use of the condemnation sale cash for closing on replacement real estate. Replacement of the condemned property must be completed by the end of the 1033 replacement period.

Unlike Section 1031, unless the relinquished property is directly converted into qualifying replacement property, the taxpayer must make a valid election to qualify for the Section 1033 roll-over. The election is made by the taxpayer purchasing the replacement property within the replacement period and filing a claim for the 1033 deferral for each year in which gain from the conversion of the condemned property is deferred.

As in a 1031 exchange, to avoid recognition of all the gain, the cost of the replacement property must equal or be more than the net proceeds received for the condemned property. The net proceeds are the total proceeds reduced by the expenses incurred in securing the award and any special assessments levied against remaining property resulting from the installation of an improvement. If the cost is less, the difference is recognized as gain and the excess is treated just like boot received in a Section 1031 like-kind exchange—it's taxable.

The rules for “replacement” of the converted property are much more workable that those for a 1031 exchange. For instance, the investor can qualify for a 1033 exchange by buying stock in a corporation owning qualified replacement property. However, the investor must buy a controlling interest. The term control means ownership of 80% or more of the total combined voting power of all classes of stock entitled to vote and 80% or more of the total number of shares of all other classes of stock of the corporation.

Forming a new corporation to acquire the replacement property is also permitted. However, the qualified replacement property must be owned by the corporation at the time the taxpayer gets control of the corporation.

Additionally, the taxpayer may reinvest the net awards into property already owned as long as the like-kind test is met. See, Davis v. United States, 411 F. Supp. 964 (aff'd, 589 F.2d. 446).

For all other property (including real property converted as a result of casualty or destruction), the taxpayer has two years to roll over the proceeds into a new investment and the replacement property must be “similar or related in service or use”.

The “similar or related” test is narrower where real estate is concerned. Such a test focuses on whether the property is functionally similar to and has the same uses as the property being converted, which usually means that the properties are physically similar and the taxpayer's relationship to each of them is substantially the same.

As can be seen, a 1033 exchange has substantial benefits over a 1031 exchange, however, the downfall is that the exchange is dealing with property that is subject to condemnation, and the market for such may be very limited. It may be difficult to obtain financing for any such property, as the property may not be considered liquid by lenders. Hence, it may be very difficult to find a buyer for condemned property or a lender, even if a buyer is found. In some instances, the condemning authority may be the only viable buyer. For condemnation purposes, the condemning authority (or its agent) assesses the value of the condemned property for purposes of the condemnation, thereby establishing a floor value on the purchase price. Certain parties may be willing to purchase the property at a discount prior to the assessment, banking on receiving more funds upon actual condemnation by the condemning authority. Other parties may be willing to purchase the property even after assessment, believing additional value may be extracted from the condemning authority by disputing the condemning authority's assessed value.

It would be beneficial to combine the benefits of a 1031 exchange with a 1033 exchange, and eliminate many of the detriments. In particular, it would be beneficial to increase the market for condemned properties, making disposition easier, and it would be beneficial to allow parties exercising a 1031 exchange the ability to use the funds from the sale of the exchanged property, and extend the time period of a 1031 exchange to that of a 1033 exchange. It would be beneficial to meld the properties of the 1033 exchange with a 1031 exchange and 1031 TIC Exchange and receive the benefits of both.

### SUMMARY OF THE INVENTION

It is an object of the present invention to provide methods and an investment instrument for investing in real estate that provide additional time to defer taxes on gains.

It is a further object of the present invention to provide an investment that permits substantial tax-deferral benefits and may be readily alienated.

It is a still further object of the present invention to provide a system for implementing methods that enable investors to realize substantial tax-deferred benefits in accordance with IRC section 1033 for property subject to section 1031 exchanges.

### BRIEF DESCRIPTION OF THE DRAWINGS

FIG. 1 diagrams a 1031 exchange

FIG. 2 diagrams 1 1033 exchange

FIG. 3 diagrams a combined 1031 and 1033 exchange

### DETAILED DESCRIPTION OF THE INVENTION

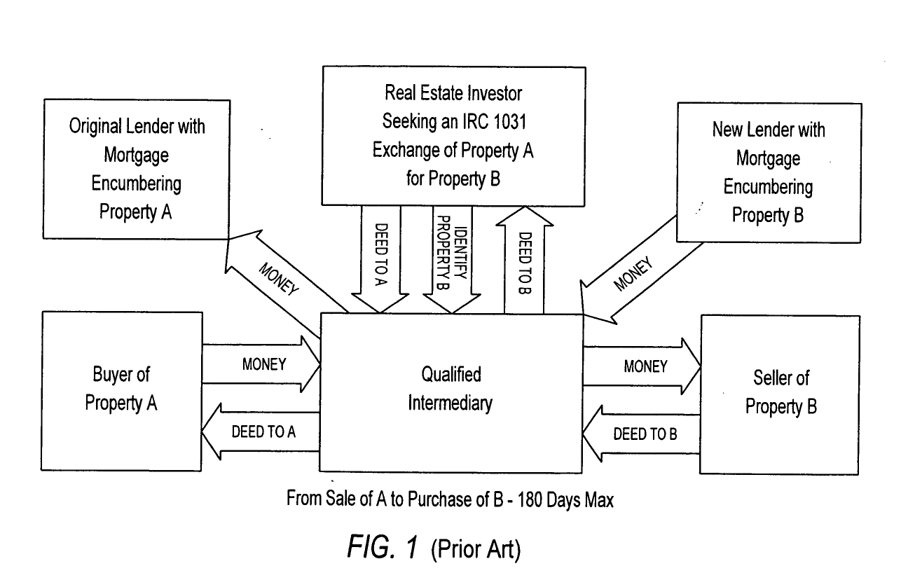

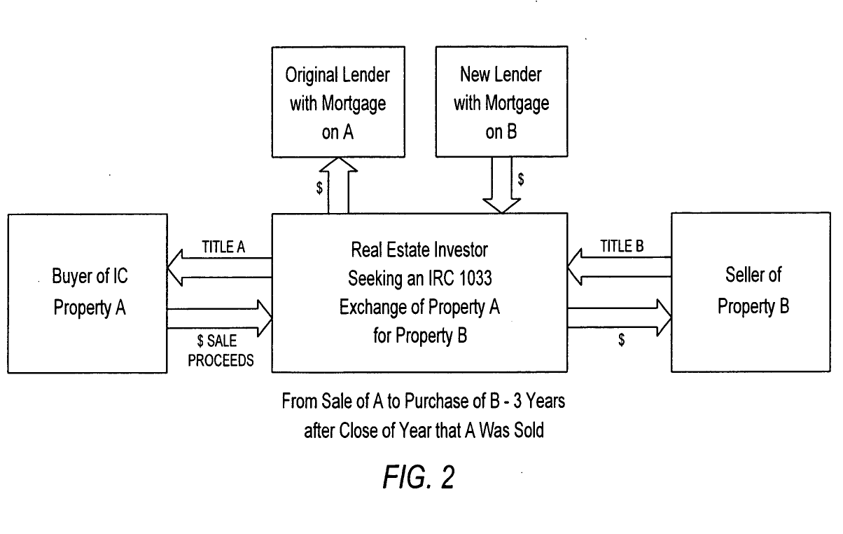

Referring to FIG. 1, a prior art exchange according to IRC section 1031 (Title 26, United States Code Section 1031) is shown. Referring now to FIG. 2, a prior art exchange according to IRC section 1033 is shown.

### 1031-1033 Simple Exchange

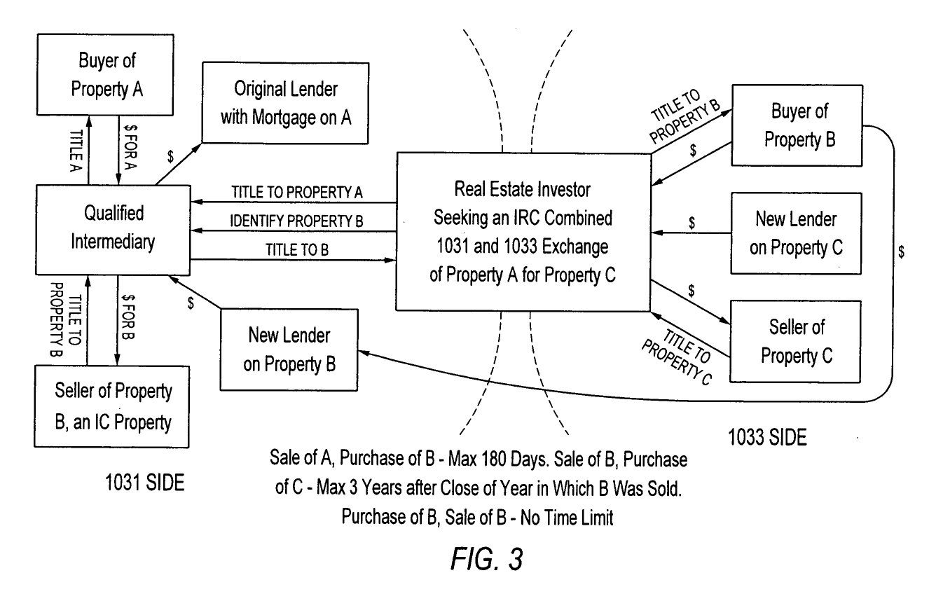

FIG. 3 shows the current invention, a sequential (or simultaneous) 1031 exchange followed by a 1033 exchange. The “replacement property” used in the 1031 exchange is a property subject to involuntary conversion (“IC Property”) (generally, under threat or imminence of condemnation). As shown in FIG. 3, investor owning real property A and desiring to sell, identifies a replacement property that is IC Property. Generally, investor will contact a Sponsor or Broker who will have a portfolio of readily identified and suitable IC Properties. The Broker will help the investor select a suitable IC Property. Information to help the investor choose suitable properties include: projected date of condemnation (if actually condemned), the timing of the notice of intent to condemn, valuation of the property, the “kind” of the property for “like-kind” exchange purposes, the assessed value of the property by the condemning authority (if available), revenue stream generated by the property, the purpose of the condemnation (e.g. for economic development, for roads, etc) and other relevant factors. The Broker may own the IC properties, or be an intermediary arranging for the owner of the IC property to sell to the exchanger.

Once a suitable IC Property is selected, the investor contracts to purchase the selected IC Property, subject to the sale of investment property A, in accordance with the time period provide by 1031 exchange regulations and subject to the rules governing a 1031 exchange. That is, in accordance with FIG. 1, the investor owning property A to be exchanged for an IC property (as shown, property B) contracts with a Qualified Intermediary (“QI”) to undertake the 1031 exchange. Investor provides the deed to property A to the QI and the investment property A is put on the market. An offer to purchase the investment property A by a third party is accepted and signed by the QI. Escrow for the sale is opened, and the QI sends required exchange documents to the escrow closer for signing at property closing. Escrow closes, with payment of any mortgage holder on property A. Within the first 45 days after the close of escrow on the sale of the relinquished property, the investor specifies the replacement properties B (here, an IC property). The investor, with the help of the Broker or Sponsor (the terms “Broker and Sponsor” are used interchangeably) (which may be the Qualified Intermediary), may have identified the needed IC properties before the transaction was initiated, but in any event, must specify the replacement properties no later than 45 days after closing (the “Identification Period”). Within 180 days after the close of escrow on the sale of the relinquished property, the investor closes on one of the identified replacement properties. The QI handles the transference of monies, and may arrange for mortgaging of the replacement property in the amount needed to satisfy the 1031 exchange rules. Investor A generally receives no cash or boot unless the exchanged IC property is sold for less than Property A. In this event, the investor 10 would have to incur taxes on the difference. After closing on the IC Property, the investor, in effect, has “exchanged” his investment property for like-kind IC Property (or a mix of IC property with non-IC property).

If conversion is imminent, the investor can wait for the transfer of the selected property to the condemning authority. Upon transfer to the condemning authority, the investor claims the benefit of a 1033 exchange, and according to the rules governing this exchange, and may access the sale proceeds during the replacement period for a 1033 exchange prior to replacing the IC Property with a like-kind property. Alternatively, or if the conversion date is too far in the future for the investor's purposes, the investor may transfer the IC Property to another investor as a section 1033 exchange. For a 1033 exchange, a Qualified Intermediary is not needed, and the seller may retain the funds from the sale during the 1033 replacement period before purchasing suitable replacement property. In this instance, the Broker may assist the holder of the IC property to sell and confect a 1033 exchange. In any event, the investor now has access to the proceeds of the sale of the IC Property, subject to the rules of section 1033, and is not required to reinvest the proceeds into like-kind property for the replacement period provided for by rule 1033. Obviously, the combined 1031/1033 exchange can generate income for the Broker or Sponsor, such as a fee for finding suitable replacement IC properties, a commission on the sale of the 1031 property or 1033 property, and fees for negotiating with the condemning authorities for fair market. As described, the above process is an exchange of property A for property B, an IC property. However, the combined exchange may also be undertaken using a TIC structure of 1033 property (i.e. IC Properties).

### 1031-1033 TIC Exchange

Alternatively, the investor may elect to transfer his investment property in exchange for a co-ownership interest in a group of aggregated properties. In the case, the underlying properties subject to common ownership will be IC Properties. The structure of the TIC properties may include a mix of both IC and non-IC properties in the underlying aggregated properties, but only the IC Property portion in the aggregate would benefit from the 1033 exchange rules. For purposes of explanation, the following description assumes all aggregated properties are IC Properties. In this instance, the 1033 qualified aggregated properties held for joint co-ownership and used for this particular exchange should be owned and managed according to the section 1031 rules.

An example of a TIC structure of IC Properties will be described from the initial establishment of the TIC structure. In this embodiment, a Broker or Sponsor would gather investors desiring to enter into a TIC 1031-1033 exchange, and identify appropriate IC Properties to aggregate for a TIC arrangement to meet the needs of the investors for a like-kind 1031 exchange (the aggregation of property may not be needed if a single property would meet the needs of the investors). The Broker would engage a Qualified Intermediary from which to perform a 1031 exchange (the Broker may be the QI). The arrangement with the investors should deal with timing issues on the sale of the investor held properties. For instance, consider two investors (C & D) holding property C and property D respectively. Broker and investors C & D enter into an arrangement where the Broker identified suitable IC properties (say properties E, F and G) to be exchanged in a 1031 exchange. The Qualified Intermediary set up the escrow account to handle the sale of properties C & D, and properties E, F, and G.

Several alternatives are possible for confecting the exchange. The Broker may be the owner of properties E, F, and G (or acquire the properties to sell to investors C and D), or the Broker may simply arrange for the owners of properties E, F, and G to agree to sell to investors C and D. Investors C and D enter into an agreement to purchase properties E, F, and G, pursuant to a purchase agreement of co-ownership, subject to the sale of investor property C and D. The co-ownership agreement is drawn up and the management structure to manage the aggregated properties agreed upon. It may be necessary for one or more owners of property E, F and G to enter the co-ownership agreement. For instance, suppose E, F, and G agree to sell to C & D in a specified percentage interest in the aggregated properties E, F, and G. Purchase of investor C's interest in the aggregated properties is conditioned on the sale of property C, and it may be necessary to delay the closing on property C based upon the timing for the sale of property D. However, in some instances, this may not be possible, particularly if the sale of property D is not imminent. Alternatively, if C sells well before D, then C's sale could go forward, but it may be necessary for C to purchase owner E's property and a portion of owner F's property as a co-owner with F. F would keep an interest in property F to sell to D upon the sale of D's property. D would purchase the remainder of F's property (now a co-owner with D) and purchase owner G's property. In this instance, C has exchanged his property for property E and a portion of F in co-ownership with F, and D would have later purchased a portion of F in co-ownership with D and also purchased G's property.

Alternatively, E, F, and G may sell the needed interest in each property to C, and hold the remaining interest until D closes, then sell the remaining interest to D. After the sale to D, C and D are now co-owners of all aggregate properties, and the co-ownership agreement can be executed between C and D.

There are various alternatives, but juggling the timing of sales can become convoluted and will usually only be undertaken if there is a need to limit the number of instances of sale of the IC property. Alternatively, if the Broker has a series of investors desiring a 1031/1033 exchange, and a number of IC properties identified, the Broker should be able to mix and match the various investors to a package of selected IC properties and account for timing differences in the sale dates of the investors' property. For instance, the agreement to purchase can include a clause that allows the purchaser (for instance, one whose investment property has not sold) to “sell” or transfer their purchase agreement for a co-ownership interest in a select TIC aggregate to another investor (one whose investment property sale is imminent and for whom the buy makes sense).

A less cumbersome means to handle timing issues, but requiring an additional transfer of ownership of the IC properties, would be to have the Broker or a third party Sponsor purchase the needed IC properties, and split the ownership into co-ownership interests as needed for the transaction for investor B & C. Alternatively, the Broker of Sponsor may purchase IC properties and aggregate the IC properties into a TIC property, with ownership percentage interest valued at incremental values (for instance, a 0.1 interest valued at $10,000), much like the deedshares described in the U.S. Pat. No. 6,292,788 patent. The Broker (or Sponsor) would re-title the property in co-ownership interests at designated values. In this fashion, the Broker (or an investor) can create packages of interests in IC aggregate properties. A Co-owner's Agreement and Management Agreement are established for the aggregated properties, (now considered a TIC structure of IC properties) as required for 1031 purposes, but with modifications as needed to deal with the issue of conversion (for instance, the manager may be granted power to negotiate for the co-owners with the condemning authority). The TIC structure includes a Co-Owner's Agreement and a Management Agreement, where the manager manages the property for the co-owners (e.g, runs the property on a day-to-day basis, makes repairs and needed additions, collects rent, pays bills, etc and accounts to the co-owners for their respective share of the revenues and expenses generated by the TIC property). An alternative management structure is to have the “manager” be a master lessee, where the manager and co-owners execute a master lease agreement where the manager leases the aggregated properties for a fixed monthly rental, and the master lessee is allowed to sublease the aggregated properties. The master lessee pays rent to the co-owners according to the master lease agreement providing a sum certain to the co-owners, and the master lessee generates income from subleasing the properties; the master lessee may or may not share a percentage of the revenues generated from subleasing with the co-owners.

The Broker or Sponsor may then sell the proper number of TIC ownership interests in the aggregated IC properties to investor C upon the sale of property C, and upon the sale of property D, sell the appropriate number of co-ownership interest to investor D. This concept can be expanded so that investor C may replace his investment property C with ownership interests in one or more TIC aggregate condemned property structures, each having a co-ownership agreement and a suitable management structure.

As currently understood, the ability to take advantage of the 1033 rules should benefit the first, second, and later purchasers of IC property; however, the government may restrict the ability of later purchases to take advantage of the 1033 exchange rules. For this reason, it may be necessary to keep the transfers of IC property to a minimum after the property becomes subject to the threat of imminent condemnation.

As described, the 1031 exchange contemplated has one critical difference from the current practices in the industry: the replacement property is IC property (property subject to imminent condemnation). Hence, an investor may take investment property (even an investment in an existing TIC structure of non-condemned properties), undertake the 1031 exchange as described above, and the replacement property is an interest in condemned property. Hence, the investor may now take his interest in condemned property, and sell it subject to 1033 exchange rules—for instance, the investor may transfer his interest in condemned property to a Broker, or transfer to another investor. Upon transfer, the investor has access to the funds generated from the sale, and now has years to invest the proceeds prior to purchasing replacement property. This time period allows an investor anticipating a downturn in real estate to sit on the sidelines for a time period prior to re-investing. Alternatively, the investor can simply hold the interest in condemned property, and wait for the condemning authority to convert the property.

Purchase of IC property provides an investor with a definite exit strategy, generally with a fairly well understood floor—hold the property for conversion by the condemning authority at fair market value. This exit strategy distinguishes the method for existing 1031 replacement properties (even in a prior art non-condemned property TIC structure), as the sale of non-condemned replacement property requires a buyer, but the condemned property has a buyer. Hence, the purchase of condemned properties for a 1031 exchange may be seen as a less risky venture, with a possible upside for fair market evaluation. This technique (1031/1033 exchanges) structure should generate interest and additional market opportunities for condemned properties, where otherwise interest may be non-existent.

For Brokers or Sponsors, a 1031/1033 combined exchange provided additional opportunities to generate commissions or fees—fees for establishing a TIC structure of condemned properties, management or leasing fees or commissions, consulting fees to find suitable TIC structures or condemned properties for the 1031 exchange, commissions on the sale of the 1033 property, fees for negotiating with the condemning authority for conversion of the property, etc. FIG. 3 does not show explicitly the situation of the Broker or Sponsor, as the Broker or Sponsor could interrelate with the investor desiring the 1033/1031 exchange on any or all of the contemplated transactions of properties.

Finally, by combining the benefits of 1031 with 1033, the taxpayer may determine to simply pay the taxes on the sale of the 1033 property after or before the replacement period. For instance, suppose the market takes a substantial upswing during the replacement period that the taxpayer believes is not supportable. Instead of investing in over-valued real estate, the investor may hold the sale proceeds during the 1033 replacement period in the hopes that the market returns to normalcy. At the end of the 1033 replacement period (or during the replacement period), the taxpayer may chose to pay taxes on the entire amount, purchase a replacement property, or a smaller valued replacement property and pay taxes on the difference, or use the other options provided by 1033, thus providing several options for the investor.

I claim:

1. A method for exchanging real estate to defer taxes by a party A holding real estate property A, comprising the steps of arranging for a transfer of title to property A for money to a buyer, providing sale proceeds from the transfer of said title of property A to a Qualified Intermediary, identifying a number of replacement real estate properties B within a first specified time of said transfer of title of property A to said third party for purposes of said exchange, completing the transfer of title of one or more of the replacement properties B to party A within a second specified time period of said transfer of title of property A to said buyer, wherein proceeds to transfer said selected properties B to A is disbursed under the authorization of said Qualified Intermediary, wherein at least one of said replacement properties B is a real estate property under the threat of imminent condemnation (“IC Property”), and said step of completing the transfer of one or more replacement properties includes transfer of at least one of said identified IC Properties.

2. The method of claim 1 further comprising the steps of transferring said acquired IC Property to a third party.

3. The method of claim 1 wherein said third party is the authority providing the threat of condemnation.

4. The method of claim 1 wherein the IC Property is under notice of condemnation.

5. The method of claim 1 wherein said IC Property is an undivided tenant-in-common interest in a real estate property subject to imminent condemnation.

6. The method of claim 5 wherein said IC Property is subject to a co-owner's agreement amongst all co-owners of said IC Property, said co-owner's agreement limiting the right of co-owners to partition said co-owned real estate property.

7. The method of claim 6 wherein said IC Property also has an associated management agreement designating a third party to manage said IC Property.

8. A method of structuring an Internal Revenue Service Section 1031 exchange for an exchanger having real estate property A to be exchanged, where said exchanged property A is not under the threat of imminent condemnation, comprising the steps of identifying real estate properties subject to the threat of imminent condemnation (“IC Property”) for use as replacement properties in a section 1031 exchange, and assisting said exchanger in selecting from said identified IC Properties one or more to designate as replacement properties in said 1031 exchange within a designated period of time after transfer to title of said exchanger's property A.

9. The method of claim 8 wherein said IC Properties includes undivided tenant-in-common interests in property subject to imminent condemnation.

10. The method of claim 8 wherein said step of assisting said exchanger in selecting includes evaluating said IC properties for valuation and timing of condemnation.

11. A combined section IRS 1031 and IRS 1033 exchange transaction, comprising the steps of: (a) undertaking an IRS section 1031 exchange transaction, wherein the replacement property for the property to be exchanged includes real estate property subject to the threat of imminent condemnation (“IC Property”), and (b) transferring said IC Property to a third party, and replacing said transferred IC Property with property suitable for use in an IRS section 1033 exchange within a designated period of time.

12. A method for exchanging real estate to defer taxes by party A holding real estate property A, comprising the steps of arranging for a transfer of title to property A for money to a buyer, providing sale proceeds from the transfer of said title of property A to a Qualified Intermediary, identifying a replacement real estate property B within a first specified time of said transfer of title of property A to said third party for purposes of said exchange, completing the transfer of title of the replacement property B to party A within a second specified time period of said transfer of title of property A to said buyer, wherein proceeds to transfer said replacement property B to A is disbursed under the authorization of said Qualified Intermediary, wherein said replacement property B is a real estate property under the threat of imminent condemnation (“IC Property”).
